(19) United States
(12) Patent Application Publication
(10) Pub. No.: US 2011/0161467 A1
(43) Pub. Date: Jun. 30, 2011

(54) METHOD AND SYSTEM FOR COMMUNICATING DATA BETWEEN ELECTRONIC BOOK DEVICES

(75) Inventors: Li LI, SHANGHAI CITY (CN); Liang HUANG, SHANGHAI CITY (CN); Shih-Kuang TSAI, SHANGHAI CITY (CN)

(73) Assignee: INVENTEC APPLIANCES CORP., TAIPEI HSIEN (TW)

(21) Appl. No.: 12/975,051

(22) Filed: Dec. 21, 2010

(30) Foreign Application Priority Data
Dec. 25, 2009 (TW) 98145027

(51) Int. Cl. G06F 15/16; G09B 5/00

(52) U.S. Cl. 709/219; 434/350

(57) ABSTRACT

The present invention provides a method and a system for communicating data between E-book devices. The system includes a first E-book device, a second E-book device and a server. The server includes a file receiving module, an identifier analyzing module and a data transmitting module. The method is described as follows. A first file is loaded into a first E-book device, and a first identifier is added into the first file. Then the first file is uploaded to a server. Then a second E-book device for receiving the first file is determined based on the first identifier. And the first file is transmitted from the server to the second E-book device. A second file derived from the first file can also be transmitted to the first E-book device according to the described method.

### RELATED APPLICATIONS

This application claims priority to Taiwan Application Serial Number 98145027, filed Dec. 25, 2009, which is herein incorporated by reference.

### FIELD OF INVENTION

The present invention relates to a method and system for communicating data. More particular, the present invention relates to a method and system for communicating data between electronic book (E-book) devices.

### BACKGROUND ART

Education plays an important role in modern society. Although it is advocated that the course load of the students should be reduced, students nowadays still experience high level of academic stress. Besides, students often carry weighty backpacks/schoolbags loaded with textbooks, homework assignments, handouts, stationery and other personal belongings. As for the teachers, the burden of grading the homework assignments may impose excessive workload to the teachers, and hence, they may have to carry piles of assignments home to complete the grading/reviewing. Further more, traditional printed textbooks are made from pulp; however, the use of wood pulp to create paper has led to a number of environmental concerns.

On the other hand, with the continuing advancement of computer technology, multimedia teaching system appears to be promising. For example, display devices such as televisions and projectors are widely employed by teachers to improve the teaching-learning experience. Almost every school or university has its own website, and even some classes have their own websites to enhance the interaction among students, teachers, parents and school administrators.

At the same time, along with the rapid development of computer technology, electronic book devices (E-book devices) are very popular now. E-book devices have many advantages over the printed media. For example, E-book devices provide convenience to the user to search the content and alter the font and size of the content, large storage capacity for storing plenty of contents, communication means for accessing and/or downloading contents virtually anywhere and anytime. Since the contents are electronically stored in the E-book devices, the shelf space for placing/storing the printed books can be saved. Besides, the cost of the paper and printing process associated with printed media is obviated thereby lowering the price of the content. E-book devices may be designed to have aesthetic appearances and is capable of providing multimedia contents.

### SUMMARY OF THE INVENTION

In view of the above-described disadvantages regarding the conventional techniques for teaching, the present invention provides a method and a system for communicating data between E-book devices.

In one aspect, the present invention is directed to a method for communicating data between E-book devices. The method includes the steps as follows. First, a first file is loaded into a first E-book device. Then, a first identifier is added into the first file, and the first file is uploaded from the first E-book device to a server. Then a second E-book device is determined for receiving the first file, based on the first identifier. Then, the first file is transmitted from the server to the second E-book device. A second file is then loaded into the second E-book device, wherein the second file is derived from the first file. Then, a second identifier is added into the second file, and the second file is uploaded from the second E-book device to the server. The first E-book device for receiving the second file is then determined based on the second identifier. Finally, the second file is transmitted from the server to the first E-book device.

In one embodiment, each of the first file and the second file comprises an E-book, respectively.

In one embodiment, the first file comprises a file for teaching.

In one embodiment, the file for teaching includes at least one of homework, marked or corrected homework, or supplemental reading material, and the second file may include at least one of completed homework, or marked or corrected homework.

In further embodiments, the first identifier is a serial number of the first E-book device, and the second identifier is a serial number of the second E-book device.

In one embodiment, the first E-book device is in communication with the server via a wired network or a wireless network, and the second E-book device may also be in communication with the server via a wired network or a wireless network.

In another aspect, the present invention is directed to a system for communicating data between E-book devices. The system comprises a first E-book device, a second E-book device and a server. The server comprises a data receiving module, an identifier analyzing module and a data transmitting module. Specifically, the first E-book device is used for transmitting a first file having a first identifier. The data receiving module is used for receiving the first file. The identifier analyzing module is used for analyzing the first identifier to determine the second E-book device for receiving the first file. And the data transmitting module is used for transmitting the first file from the server to the second E-book device. Moreover, the second E-book device has a second file derived from the first file and having a second identifier. The data receiving module is further used to receive the second file. The identifier analyzing module is further used to analyze the second identifier to determine the first E-book device for receiving the second file. And the data transmitting module is further used to transmit the second file from the server to the first E-book device.

In one embodiment, the first E-book device is in communication with the server via a wired network or a wireless network, or the second E-book device is in communication with the server via a wired network or a wireless network.

In another embodiment, each of the first file and the second file comprises an E-book, respectively.

In further embodiments, at least one of the first file or the second file has a video content or an audio content; each of the first E-book device and the second E-book device may have a function of playing the video content or the audio content, respectively; and the server may further comprise a data storage module for storing the first file and the second file.

### BRIEF DESCRIPTION OF THE DRAWINGS

These and other features of the invention will become more apparent from the following description in which reference is made to the appended drawings, wherein:

FIG. 1 is an exemplary flow chart illustrating the method for communicating data between E-book devices according to one embodiment of the invention; and

FIG. 2 is a block diagram illustrating a system for communicating data between E-book devices according to one embodiment of the invention.

FIG. 3 is a block diagram illustrating a system for communicating data between E-book devices according to another embodiment of the invention.

### PREFERRED EMBODIMENTS OF THE INVENTION

One or more currently preferred embodiments have been described by way of example. It will be apparent to the skilled in the art that a number of variations and modifications can be made without departing from the scope of the invention as defined in the claims.

Reference is made to appended drawings to describe the method and system for communicating data between E-book devices according to embodiment of the invention. In the present specification, E-book devices used in teaching activities are used as an illustrative example to describe the embodiments.

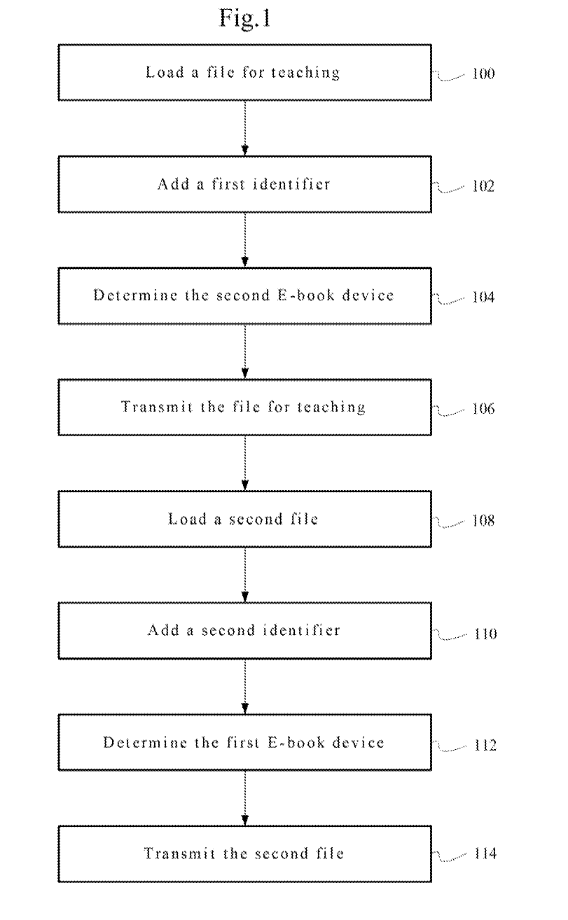

Please refer to FIG. 1, which is an exemplary flow chart illustrating the method for communicating data between E-book devices according to the embodiments of the invention. It's noted that the sequence in FIG. 1 of performing the steps of the method is for illustration purpose only and does not fix or limit the sequence of performing the steps, which is allowed to vary depending on actual circumstances of embodiments, and typical practice in the field of the invention.

In step 100, the teacher loads a first file into his E-book device (first E-book device), and the first file comprises a file for teaching which includes at least one of homework, marked or corrected homework, or supplemental reading material and so on.

Then, in step 102, the first E-book device adds a first identifier into the first file, which is then uploaded from the first E-book device to a server. In this particular embodiment, the first identifier is a serial number of the first E-book device.

In step 104, the server determines at least one second E-book device, such as the E-book devices belonging to students of a class, for receiving the first file, based on the first identifier.

Then, in step 106, the server transmits the first file from the server to the second E-book device(s) determined in step 104.

Then in step 108 of the method, each of the users of the respective second E-book device (the students) loads a second file into his/her second E-book device. In this case, the second file is derived from the first file, and may be a reply to the first file(s). For example, the second file may include at least one of completed homework, corrected homework and so on.

In step 110, each of the second E-book devices adds a second identifier into the second file loaded therein and uploads the second file from the second E-book devices to the server. In this particular embodiment, the second identifier is a serial number of the second E-book device.

Then, in step 112, the server determines the first E-book device for receiving the second file, based on the second identifiers.

Finally, in step 114, the server transmits the second file from the server to the first E-book device belonging to the teacher.

If it is necessary, step 100 to step 114 may be repeated so that the teacher and students could communicate multiple files using the first E-book device and the second E-book devices.

As should be appreciated by those with ordinary skill in the art, each of the first file and the second file may comprise an E-book, respectively. Further more, the first E-book device may be in communication with the server via a wired network or a wireless network, and the second E-book device may also be in communication with the server via a wired network or a wireless network.

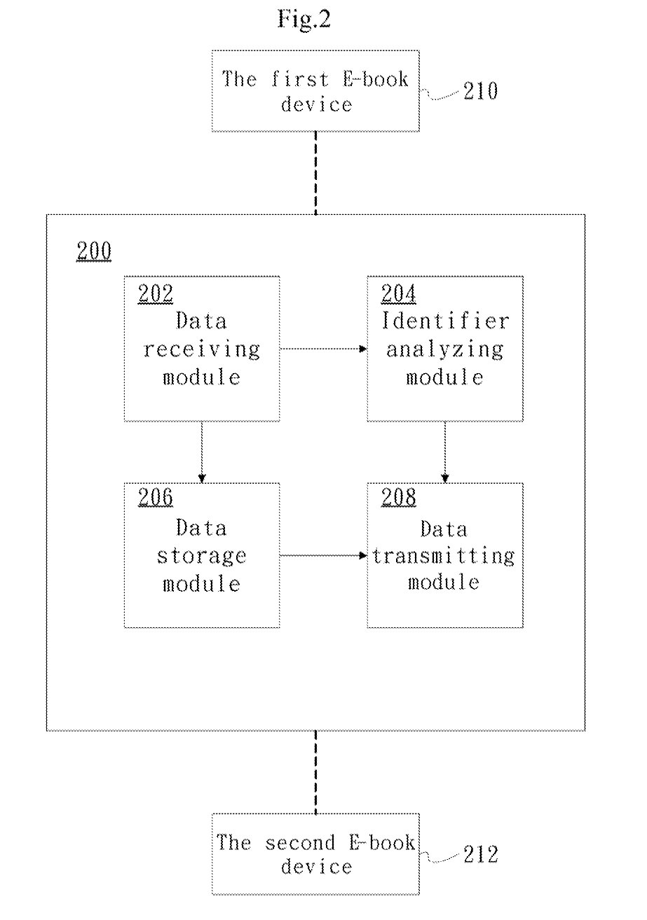

Now that the details of the method for communicating data between E-book devices for use in teaching activities has been described, reference is made to FIG. 2 to discuss the system for communicating data between E-book devices according to one embodiment of the invention. The framework of system can be readily understood through the following description regarding the components of the system.

As shown in FIG. 2, the system includes a server 200, a first E-book device 210 and a second E-book device 212. The server 200 further comprises a data receiving module 202, an identifier analyzing module 204 and a data transmitting module 208. The first E-book devices 210 and the second E-book devices 212 are in communication with the server 200 via a wired network such as a cable or a wireless network such as a 3G network. The server 200 is used for processing the data exchange among E-book devices. The data receiving module 202 is used to receive the file(s), such as E-books, uploaded from the first E-book device 210 and the second E-book device 212. In this embodiment, the server 200 further comprises a data storage module 206 for storing the file(s) uploaded from the first E-book device 210 and the second E-book device 212. The identifier analyzing module 204 is used to analyze the identifiers added to the first file and the second file, and then identify the E-book device(s) for receiving the file(s). The data transmitting module 208 is used to transmit the file(s) from the server 200 to the determined E-book device(s).

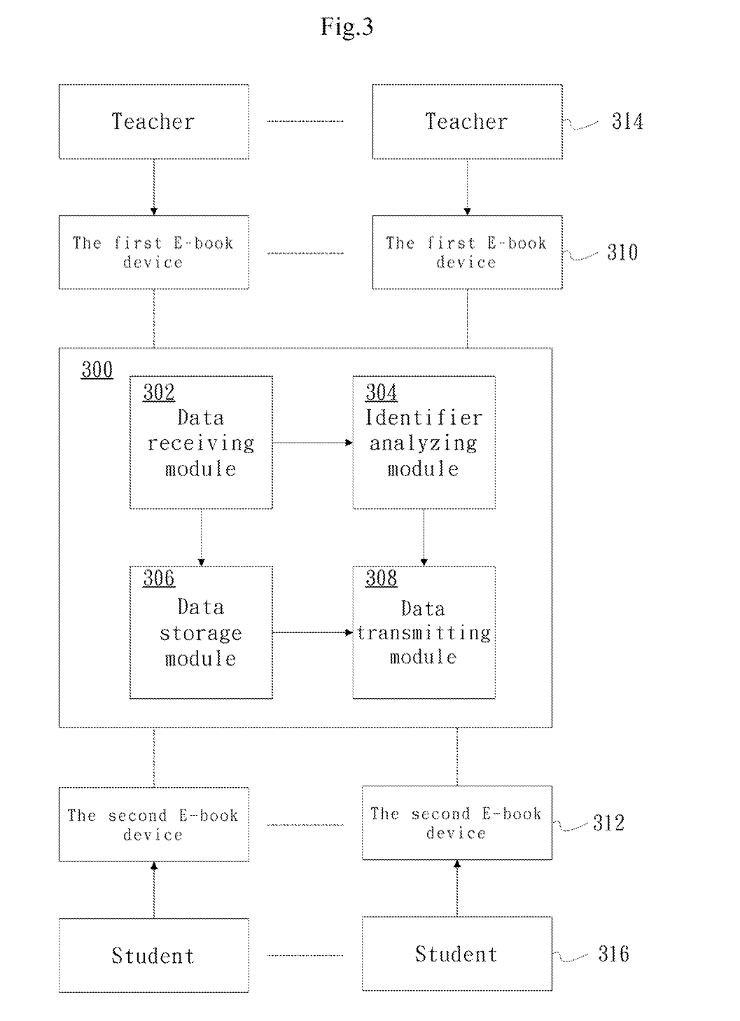

FIG. 3 is a block diagram illustrating the system of FIG. 2 adapted in teaching activities according to one embodiment of the invention. As shown in FIG. 3, multiple first E-book devices 310 and multiple second E-book devices 312 are in communication with a server 300 wirelessly. The server 300 further comprises a data receiving module 302, an identifier analyzing module 304, a data storage module 306 and a data transmitting module 308. Each of the teachers 314 may load first file(s) of file(s) for teaching into his/her first E-book device 310. Each first E-book device 310 adds a first identifier into the respective first file, and then uploads the first file(s) from the first E-book devices 310 to the server 300. The data receiving module 302 of the server 300 receives the first file(s) uploaded from each of the first E-book devices 310, respectively. Then, the first identifier contained in each first file is analyzed by the identifier analyzing module 304 of the server 302 so that the identifier analyzing module 304 may identify the second E-book device(s) for receiving the first file. Meanwhile, the data storage module 306 of the server 302 may store the uploaded first file(s) of file(s) for teaching. Then, the data transmitting module 308 transmits the first file(s) for teaching from the server 300 to the second E-book device(s) 312 determined by the identifier analyzing module 304. As the respective second E-book device 312 received the respective first file of the file for teaching, the user (student) 316 of the respective second E-book device 312 may load a second file into his/her own second E-book device 312. The second E-book device 312 adds a second identifier into each of the second files and then uploads the second file from the second E-book device 312 to the server 300. The data receiving module 302 receives the second file uploaded from the respective second E-book device 312, and then the second identifier of the second file is analyzed by the identifier analyzing module 304 to identify the first E-book reader for receiving the second file. Meanwhile, the data storage module 306 stores the second file. Then, the data transmitting module 308 transmits the second file from the server 300 to the first E-book device 312 determined by the identifier analyzing module 304. Hence, each teacher 314 may use his/her E-book device 310 to review and grade the second files turned in by the students 316.

As should be appreciated by those with ordinary skill in the art, a file for teaching (first file) loaded into a first E-book device 310 by a teacher 314 could be transmitted from the server 300 to multiple second E-book devices 312 of the students. For example, a first file containing a homework assignment may be transmitted to all students in the class. Similarly, multiple second files loaded into a second E-book device 312 by a student 316 could be sent to various first E-book devices 310 belonging to different teachers 314 based on the subject that the respective second file is associated with. The association between the second file and the subject may be implemented in either one or both of the first and second identifiers.

The file for teaching (first file) and the second file may be E-books. It is acknowledged by some experts that multimedia material containing video and/or audio contents may increase the learning intentions of students and improve the teaching-learning experience. In optional embodiments, the E-books may have a video content and/or an audio content. As such, each of the first E-book device 310 and the second E-book device 312 has a function of playing video content and/or audio content.

It will be understood that the above description of embodiments is given by way of example only. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for communicating data between electronic book (E-book) devices, comprising the steps of:
loading a first file into a first E-book device;
adding a first identifier into the first file and uploading the first file from the first E-book device to a server;
determining a second E-book device for receiving the first file, based on the first identifier;
transmitting the first file from the server to the second E-book device;
loading a second file into the second E-book device, wherein the second file is derived from the first file;
adding a second identifier into the second file and uploading the second file from the second E-book device to the server;
determining the first E-book device for receiving the second file, based on the second identifier; and
transmitting the second file from the server to the first E-book device.

2. The method according to claim 1, wherein each of the first file and the second file comprises an E-book, respectively.

3. The method according to claim 1, wherein the first file comprises a file for teaching.

4. The method according to claim 3, wherein the file for teaching includes at least one of homework, marked or corrected homework, or supplemental reading material.

5. The method according to claim 4, wherein the second file includes at least one of completed homework, or marked or corrected homework.

6. The method according to claim 1, wherein the first identifier is a serial number of the first E-book device.

7. The method according to claim 1, wherein the second identifier is a serial number of the second E-book device.

8. The method according to claim I, wherein the first E-book device is in communication with the server via a wired network or a wireless network.

9. The method according to claim 1, wherein the second E-book device is in communication with the server via a wired network or a wireless network.

10. A system for communicating file between E-book devices, comprising:
a first E-book device for transmitting a first file having a first identifier;
a second E-book device; and
a server, comprising:
a data receiving module for receiving the first file;
an identifier analyzing module for analyzing the first identifier to determine the second E-book device for receiving the first file; and
a data transmitting module for transmitting the first file to the second E-book device, wherein
the second E-book device has a second file derived from the first file and having a second identifier, the data receiving module is further used to receive the second file, the identifier analyzing module is further used to analyze the second identifier to determine the first E-book device for receiving the second file, and the data transmitting module is further used to transmit the second file to the first E-book device.

11. The system according to claim 10, wherein the first E-book device is in communication with the server via a wired network or a wireless network.

12. The system according to claim 10, wherein the second E-book device is in communication with the server via a wired network or a wireless network.

13. The system according to claim 10, wherein each of the first file and the second file comprises an E-book, respectively.

14. The system according to claim 13, wherein at least one of the first file or the second file has a video content or an audio content.

15. The system according to claim 14, wherein each of the first E-book device and the second E-book device has a function of playing the video content or the audio content, respectively.

16. The system according to claim 14, wherein the server further comprises a data storage module for storing the first file and the second file.
